(19) United States
(12) Patent Application Publication
(10) Pub. No.: US 2009/0184601 A1
(43) Pub. Date: Jul. 23, 2009

(54) POLYPHASE STATOR OF A ROTATING ELECTRICAL MACHINE WITH CLAW-POLE ROTOR AND ALTERNATOR OR ALTERNATOR STARTER COMPRISING SAME

(76) Inventors: Jean-Marc Dubus, Chevilly la Rue (FR); Arnaud De Vries, Vanves (FR); Denis Even, Paris (FR); Jean-Claude Mipo, Creteil (FR)

Correspondence Address: BERENATO, WHITE & STAVISH, LLC, 6550 ROCK SPRING DRIVE, SUITE 240, BETHESDA, MD, 20817, US

(21) Appl. No.: 12/064,264

(22) PCT Filed: Sep. 11, 2006
(86) PCT No.: PCT/FR06/50869

§ 371 Date: Jun. 24, 2008

(30) Foreign Application Priority Data
Sep. 13, 2005 (FR) 0509321

(51) Int. Cl. H02K 3/12; H02K 3/34; H02K 1/16; H02K 3/28; H02K 9/06

(52) U.S. Cl. 310/208; 310/215; 310/216.004; 310/62

(57) ABSTRACT

The invention concerns a polyphase stator (5) for a with rotating electrical machine claw-pole rotor comprising five or seven phases (132), a stator body having internally a plurality of notches delimited by teeth, each phase including at least one winding, each winding including coils with multiple turns, each coil enclosing a single tooth (61). The invention also concerns an alternator or an alternator starter comprising such a stator.

### FIELD OF THE INVENTION

The invention concerns a polyphase stator for a rotary electrical machine with a claw rotor, of the polyphase alternator or alternator starter type, and an alternator or alternator starter comprising such a stator.

The invention finds applications in the field of the automotive industry and in particular in the field of alternators and alternator starters for motor vehicles.

### BACKGROUND OF THE INVENTION

In a motor vehicle, the polyphase alternator converts a rotation movement of the inducing rotor, driven by the thermal engine of the vehicle, into an induced electrical current in the stator coil. The alternator may also be reversible. It then constitutes an electric motor that can, via the rotor shaft, drive the thermal engine of the vehicle in rotation. This reversible alternator is called an alternator starter. The alternator converts mechanical energy into electrical energy. The same applies to the alternator starter when it is functioning in current generator mode. When the alternator starter is functioning in electric motor mode, in particular to start the thermal engine of the vehicle, the alternator starter converts electrical energy into mechanical energy.

In an alternator or in an alternator starter functioning in current generator mode, the stator is an induced stator and the rotor an inducing rotor. In an alternator starter functioning in electric motor mode, the stator is an inducing stator and the rotor an induced stator.

More precisely the alternator or alternator starter comprises a casing in at least two parts, referred to as front bearing housing and rear bearing housing, carrying a stator surrounding a rotor secured to a rotor shaft, which carries at one of its axial ends a movement transmission member, such as a pulley or gear, belonging to a movement transmission device acting between the thermal engine and the alternator or alternator starter.

The rotor comprises at least one inducing coil connected to a voltage regulator. The stator comprises a body carrying a coil composed of several phases, each comprising at least one winding, the outputs of which are electrically connected to a rectifying device for rectifying the alternating current produced in the stator phases, when the stator is an armature, into direct current for recharging the battery and/or supplying the consumers in the onboard system of the vehicle. This rectifying device comprises for example a diode bridge.

In a variant the rectifying device comprises a transistor bridge, for example of the MOSFET type, in particular in the case of an alternator starter, and a control device is provided in order in particular to inject current into the stator phases when the alternator starter is functioning in electric motor mode.

The inducing coil of the rotor may be fixed and be connected to the voltage regulator or in a variant be located in the rotor. In this case the rotor shaft carries at its other axial end collecting rings connected by hard-wired connections to the ends of the inducing coil. Brushes rub on the collecting rings. These brushes belong to a brush holder connected to the voltage regulator.

The stator body is usually produced in the form of a packet of metal sheets in order to reduce eddy currents.

These sheets comprise a plurality of notches. These notches are aligned to form a plurality of axial grooves.

The notches are of the closed or semi-closed type and in this case each have an opening that emerges at the internal periphery of the stator body. These notches are delimited in alternation by teeth, two consecutive notches being separated by a tooth.

The windings of the stator coil are mounted in the notches, the number of which varies according to the application and the number of phases. For example, the alternator or alternator starter, being of the three-phase type and the rotor being a claw rotor comprising two pole pieces each having six teeth, the stator in this case comprises 36 notches.

In one embodiment the windings are continuous-wire windings produced for example in an undulating manner or interleaved in the notches around several teeth. With continuous-wire windings the rate of filling of the notches by the windings is not as high as wished.

In a variant, in order to increase the power of the machine and to increase the filling rate of the notches, the windings are bar windings comprising pins connected to one another by soldering.

Such an arrangement requires carrying out numerous soldering operations.

In order to reduce the ripple factor of the induced current and therefore of the voltage it is desirable to double the effective number of windings in order to have two notches per pole and per phase. For example, in the aforementioned case of a claw rotor having six teeth per pole piece, the number of notches is then 72. For a claw rotor with eight teeth per pole piece the number of notches is 96.

In this case the teeth delimiting two consecutive notches cannot be as thick as desired, except by increasing the size of the stator body.

### SUMMARY OF THE INVENTION

An object of the invention is to remedy the drawbacks of the techniques disclosed above.

One aim of the invention is to be able to reduce the ripple factor of the voltage without needing to double the number of teeth.

Another aim of the invention is to increase the filling rate of the notches compared with a solution with continuous-wire windings.

Another aim of the invention is to reduce the number of soldering operations compared with a solution with windings with bars.

To this end the invention proposes a polyphase stator for a rotary electrical machine with a claw rotor, comprising a stator body having internally a plurality of notches delimited by teeth, each phase comprising at least one winding, characterised in that, in combination, firstly, each phase winding comprising coils with several turns, each coil surrounds a single tooth, and secondly the stator comprises five or seven phases.

According to the invention an alternator or an alternator starter is characterised in that it comprises such a stator.

By virtue of the invention the number of phases is increased, the stator comprising five or seven phases, while having wide teeth.

The increase in the number of phases makes it possible to reduce the ripple factor in the voltage and the acoustic noise of the alternator or alternator starter while having wide teeth and without having to increase the radial size of the stator body.

Advantageously, the invention makes it possible to increase the filling rate of the notches and to reduce the number of soldering operations since the coils are connected together in order to form a phase.

In one embodiment the stator comprises seven phases and twenty eight notches.

In another embodiment the stator body has an inside diameter of between 90 millimetres and 115 millimetres. The minimum value of the inside diameter of the stator body provides sufficient operating torque for the electrical machine, in particular during the phase of driving the thermal engine, in the case of a reversible electrical machine. In addition, the aforementioned maximum value of the inside diameter of the stator body provides reasonable inertia for the electrical machine.

In general terms the increase in the number of phases also makes it possible, when the alternator starter is functioning in electric motor mode, to act on the rectifying device less in terms of amperage, the latter then comprising a large number of components, such as transistors of the MOSFET type.

In reality each transistor comprises several transistors connected in parallel so that it is possible, for each transistor, to reduce the number of transistors when the number of phases is increased. The solution is therefore economical.

With an increase in the number of phases better functioning and greater power is obtained when the alternator starter is functioning in electric motor mode.

In all cases, the teeth have a large cross section so that it is possible to increase the active length of iron facing the rotor.

These teeth are also simplified as they have no root. In one embodiment the notches are open towards the inside.

The stator teeth have parallel edges and the turns of the coils have a constant width.

In a variant, the notches have parallel edges and the turns of the coils have a non-constant width.

The coils are preformed in a cluster, which makes it possible to reduce further the number of soldering operations. The solution is compact.

By virtue of the invention it is possible to control the length of the windings projecting on each side of rotor body, that is to say the length of the coil ends, so that the solution is axially compact.

The coils comprise several turns, which may be of variable height. This makes it possible in one embodiment to vary the size of the coil outside the stator body. The length of the stator winding is therefore adjustable.

Thus, in a variant embodiment, the axial length of the coil end varies from one turn to another for better cooling.

In one embodiment the coil wire has a circular cross section.

In another embodiment a wire of the flat type is used or one with a rectangular cross section to form the coil and increase further the filling rate of the notches.

The invention affords great flexibility in the fitting of notch insulators.

More precisely in one embodiment the notch insulator is fitted in the notches before the coils are put in place.

In a variant the coil is mounted around the insulator and the assembly is then mounted on the parallel-edge teeth.

The notch insulator has a bottom edge for holding the associated coil.

In one embodiment two coils are installed in the same notch, each coil being wound around one of the teeth delimiting the notch.

In a variant a single coil is mounted per notch.

By virtue of the invention the power of the rotary electrical machine of the alternator or alternator starter type, is increased at low load.

Naturally all these variants are to be considered in isolation or in combination.

### BRIEF DESCRIPTION OF THE DRAWINGS

FIG. 1 depicts an alternator with internal ventilation provided with a stator according to the invention depicted schematically.

FIG. 2 depicts a view in perspective of a variant embodiment of a fan of FIG. 1.

FIG. 3 is a partial view in perspective of the stator body of FIG. 1 showing the teeth with parallel edges thereof.

FIG. 4 is a partial view of a coil and notch insulator assembly before its mounting by slipping onto its associated wide tooth.

FIG. 5 is a view similar to FIG. 4 of the coil and notch insulator assembly after its mounting by slipping onto its associated wide tooth.

FIGS. 6a and 6b depict perspective views from different angles of a flat-wire coil mounted on its associated tooth.

FIG. 7 depicts a stator comprising five phases connected to a rectifying device.

FIG. 8 depicts a stator comprising seven phases connected to a rectifying device.

### DESCRIPTION OF THE PREFERRED EMBODIMENT

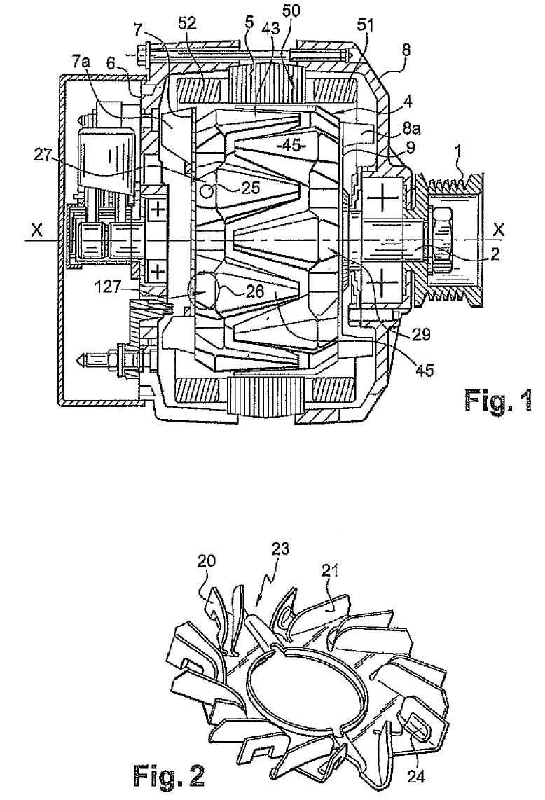

FIG. 1 depicts a polyphase alternator for a motor vehicle with internal ventilation equipped with two fans.

This alternator comprises, in the aforementioned manner, a movement transmission member 1, in the form of a pulley, belonging to a movement transmission device not shown in FIG. 1, acting between the thermal engine of the vehicle and the alternator. This member 1 has partly passing through it a rotation shaft 2 to which it is rotationally secured and the axial axis of symmetry XX of which constitutes the rotation axis of the machine. This rotation shaft 2 carries a rotor 4, for example a claw rotor, provided with at least one excitation winding. The rotor 4 is surrounded by a wound stator 5 that comprises one or more windings to constitute the armature coil. The stator 5, of the polyphase type, is carried by a front bearing housing 8 and rear bearing housing 6, both comprising at the axial ends a ball bearing carrying the rotation shaft 2.

The bearing housings 6, 8 are hollow in shape and connected together by tie rods (not referenced) to form a casing carrying internally the stator 5 according to the invention.

The rear bearing housing 6 carries a brush holder (not referenced), the brushes of which, in a known manner, are adapted to rub on collecting rings (not referenced) connected by hard-wired connections to the field winding or excitation winding (not visible) that the claw rotor 4 has between its two pole pieces 27, 29 each provided with interleaved axially oriented teeth 45. Magnetic poles are formed, at the rate of one per pole wheel tooth 45, when the rotor winding is supplied electrically.

In the example in FIG. 1, the alternator comprises two fans, a fan 9 at the front of the rotor and a rear fan 7, both secured to the rotor. Another example of an alternator could comprise only one fan, generally a rear fan 7 more powerful than the front fan 9 placed on the same side as the drive pulley 1.

Such a fan comprises a plate from which there emerges at least one series of projecting blades 8a, 7a. It is generally fixed to the rotor by welding the plate to the rotor. However, through its manufacture, a fan is generally originally asymmetric. To eliminate this imbalance, a person skilled in the art normally effects a balancing of the assembly before it is set in motion. This balancing is generally carried out by modifying the mass of the assembly so as to modify its centre of gravity. This modification of the mass is carried out by removing material in the rotor by means of piercing guns that make holes 25 in a piercing area 26 provided in the base 127 of at least claw 45 of the rotor 4, as can be seen in FIG. 1.

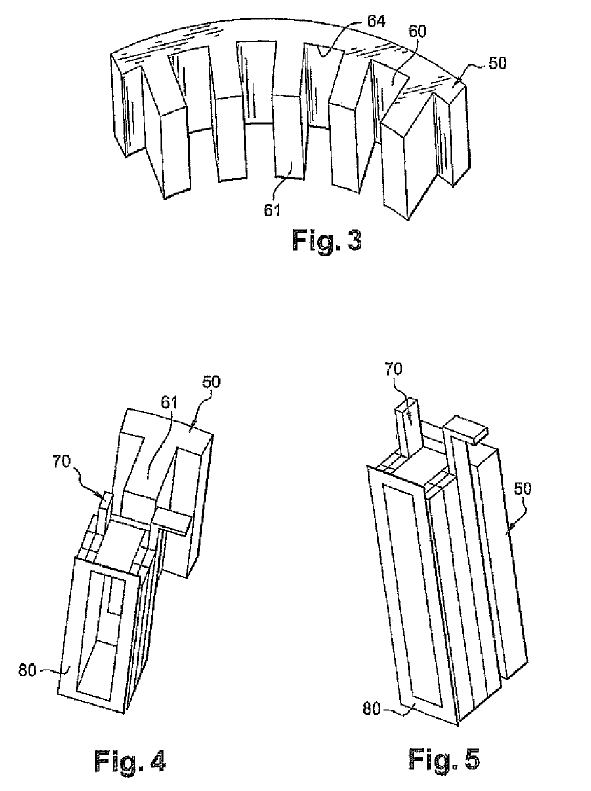

In a variant the fan 7 is replaced by a more powerful double fan 23 (FIG. 2) comprising a bottom fan 20 and a top fan 21. These fans 20, 21 are superimposed and each provided with blades, here ribbed at 24. The fan 20 is secured to the rotor 4, for example by welding or crimping. The two fans are connected together, for example by welding, adhesive bonding, riveting or crimping.

It can be seen in this FIG. 1 that the stator 5 comprises a body 50 secured to the bearing housings 6, 8 perforated for the internal circulation of the air caused by the fans 7, 9, 23. This body 50 carries a coil, described below, the ends 51, 52 of which, referred to as coil ends, extend on each side of the body 50 of the stator 5.

It is necessary to cool the coil ends 51, 52 properly by means of fans so that it is desirable for the stator coil to have a suitable configuration allowing good passage of the air at the coil ends.

In a variant the alternator is cooled by water.

In all cases it is desirable to increase the power and performance of the alternator, which in a variant is reversible and consists of an alternator starter described for example in the document WO 01/69762 or in the document FR A 2 745 444, to which reference should be made.

The body 50 if the stator 5 is produced here in the form of a packet of metal sheets in order to reduce eddy currents. This body 50, as well as the stator 5, has an annular shape. According to the applications of the invention, the stator body 50 has an inside diameter that can vary from 90 mm to 115 mm.

These extrema offer the advantage of responding favourably to the torque and inertia constraints of the electrical machine.

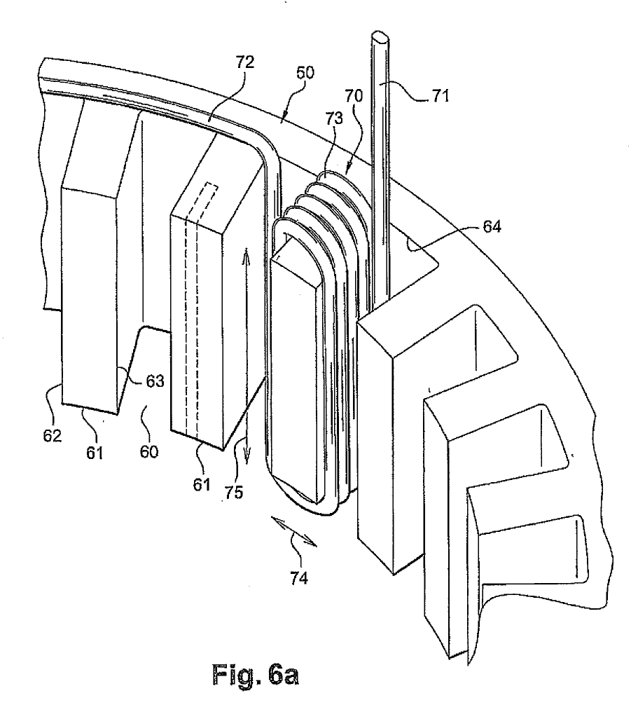

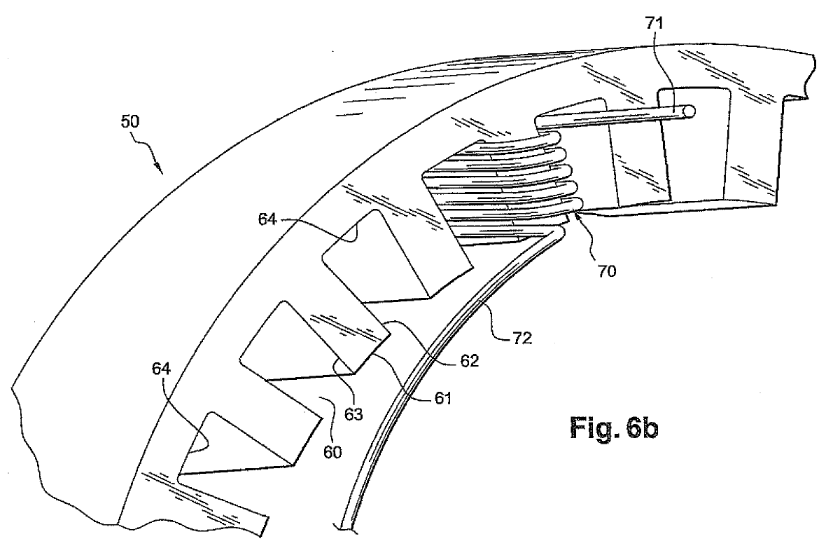

These metal sheets comprise a plurality of notches 60 (FIGS. 3, 6a and 6b). These notches 60 are aligned to form a plurality of axial grooves.

The notches 60 are here of the type open towards the internal periphery of the body 50. This internal periphery delimits a cylindrical bore with the presence of a small air gap between the internal periphery of the body 50 of the stator 5 and the external periphery of the rotor 4 made from ferromagnetic material and with an annular shape.

These notches 60 are, according to one characteristic, open here towards the inside and are delimited in an alternating fashion by teeth 61, two consecutive notches 60 being separated by a tooth 61. The body 50 is therefore of simple manufacture.

The teeth 61, according to one characteristic of the invention, have parallel edges 63, 62. These teeth are very wide, a band of material, referred to as the frame, existing between the bottoms 64 of the notches 60 and the external periphery of the body 50.

According to one characteristic use is made of the parallel edges 63, 62 to mount preformed coils 70. In a variant, the coiling can be carried out directly on the stator teeth.

More precisely the alternator or alternator starter is of the polyphase type and therefore comprises a stator coil comprising several phases, each phase comprising at least one winding so that the stator is polyphase.

Each phase winding comprises a plurality of coils 70. These coils 70 are produced from a wire coiled several times in order to form several turns 73. These turns 73 have a width 74 and a height 75.

In FIGS. 6a and 6b five complete turns and two incomplete turns are formed in order to constitute an input 71 and an output 72.

In FIGS. 6a and 6b the wire is of the flat wire type. In FIGS. 4 and 5 the wire is a wire with a rectangular cross section.

These wires are positioned so that their widest side is parallel to the edges of the notches, which makes it possible to reduce the width of the coil ends.

The wires have a constant cross section and consist for example of a copper wire coated with enamel.

Thus, according to one characteristic, each phase winding comprises coils 70 having turns of constant width. These coils 70 are mounted around teeth 61 with parallel edges 62, 63.

In a variant only one coil is mounted per notch.

The coils 70 are interconnected together, for example by soldering, then to form a phase.

In a variant the coils 70 are formed in clusters and slipped onto the teeth at the rate of n stator body teeth per n phases.

A good filling rate of the notches 60 is obtained with a minimum of interconnection by soldering.

It is possible to increase the number of phases without increasing the size of the body 50.

Thus, for the same size of the body 50, a three-phase stator with a hard-wired winding of the prior art comprises 48 notches while a stator with five phases according to the invention comprises 20 notches, that is to say 20 teeth. In a variant the polyphase stator according to the invention comprises 7 phases and 28 notches, that is to say 28 teeth.

The width of the teeth according to the invention is greater than that of the teeth of the prior art with reduction in noise and ripple factor.

Naturally it is possible to connect the coils 70 in series or in parallel.

It is possible to vary the height of the turns 73 each time in order to obtain better cooling by means of the fans in FIGS. 1 and 2.

A good passage of air is obtained at the head of the coils 70 comprising overall two parallel edges connected by two rounded edges (FIGS. 6a and 6b). The coils 70 therefore have an oblong shape and are therefore well cooled by the circulation of air caused by the fan or fans of FIG. 1. In addition the solution is quiet.

In a variant, each phase winding comprises coils 70 having turns of non-constant width. These coils 70 are mounted for example in notches with parallel edges 63, 65.

FIGS. 6a and 6b do not show the notch insulator interposed between the coils 70 and the edges 61, 62 as well as the bottom 64 of the notch 60 in order to insulate the coils 70 from the body 50 and avoid damaging the insulator on these.

More precisely, in one embodiment, the notch insulator is fitted in the notches before the coils are put in place.

In a variant each coil 70 is mounted around the notch insulator 80 and the assembly 70-80 is then mounted by simple radial slipping onto the relevant teeth 61 with parallel edges.

The insulator 80 has a bottom edge, here rectangular in shape, visible in FIG. 5.

This bottom edge therefore enters two consecutive notches 60 and holds the coil 70. Provision is also made for providing the notch insulator with a top edge adjacent to the bottom 64 of the notch.

The edges are perpendicular to the edges 62, 63 of the tooth 61 so that the insulator 80 has a groove for housing the coil 70 formed in advance on a template.

The insulator 80 is in one embodiment preimpregnated. In a variant it is impregnated so that, after cooling, it becomes integral with its associated tooth.

In one embodiment two coils 70 are located in the same notch, each coil being wound around one of the teeth delimiting the notch.

The solution is also axially compact.

The teeth can be split as can be seen in broken lines in FIG. 6a.

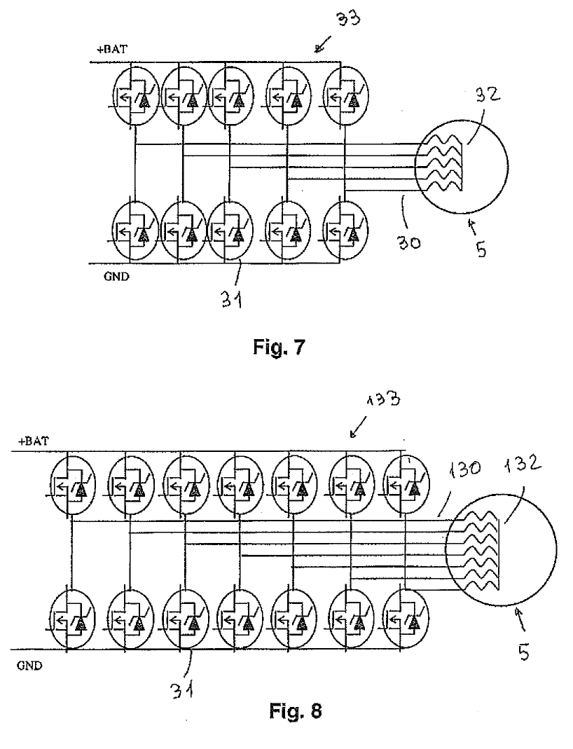

In FIGS. 7 and 8 the aforementioned embodiments of the invention with five or seven phases can be seen.

As shown by FIG. 7, the outputs 30 of the windings 32 of the stator 5 are electrically connected to a rectifying device 33. The stator has five phases and the rectifying device 33 comprises ten transistors 31 of the MOSFET type.

FIG. 8 depicts the outputs 130 of the windings 132 of the stator 5 electrically connected to a rectifying device 133. The stator 5 has seven phases and the rectifying device 133 comprises fourteen transistors 31 of the MOSFET type. According to this particular embodiment of the invention, the seven phases of the stator offer the advantage of reducing the current passing through the rectifying device 133 while having a good reduction of the ripple factor and wide teeth.

In these FIGS. 7 and 8, in a known manner, the reference GND corresponds to the vehicle earth and the reference +BAT to a voltage corresponding to the voltage of the positive terminal of the motor vehicle battery.

As is clear from the description and drawings, in combination, firstly, each winding of the multiphase stator comprises several coils with several turns, each coil surrounding a single tooth, and secondly the stator comprises five or seven phases.

Once round a tooth corresponds to a turn.

In the embodiments in FIGS. 7 and 8 the claw rotor 4 comprises eight teeth 45 per pole piece 27, 28 while the body 50 of the stator 5 comprises four teeth per phase, that is to say respectively 20 and 28 teeth.

The number of teeth, or notches, per stator phase is therefore equal to half the number of teeth on a pole piece 27, 28.

When the coils 70 are formed in clusters, they are formed by a single wire constituting the coils and the interconnections between the coils.

The rectifying device is carried by the rear bearing housing or, in a variant, in particular when the alternator is reversible, by a casing external to the alternator. It is electrically connected to the stator, or more precisely to the outputs of the phases thereof.

Naturally the invention is not limited to the particular embodiments described in the present application. It is clear that various modifications can be made by a person skilled in the art according to the application envisaged without for all that departing from the scope of the accompanying claims.

For example, the claw rotor 4, in a variant embodiment, comprises 4, 6 or 10 teeth per pole piece. In these cases the body 50 of the stator comprises respectively three or five teeth per phase.

More precisely, for a claw rotor with six teeth per pole piece, the body of the stator comprises 15 teeth when it comprise five phases and 21 teeth when it comprises seven phases.

For a claw rotor with ten teeth per pole wheel, the body of the stator comprises 25 teeth when it comprises five phases and 35 teeth when it comprises seven phases.

For a claw rotor with four teeth per pole piece, the stator body comprises 10 teeth when it comprises five phases and 14 teeth when it comprises seven phases.

In a variant the number of teeth per stator phase is equal to or twice the number of teeth on a pole piece.

Thus, for a rotor with pole pieces with six teeth, the body of the stator comprises, in one embodiment, six teeth per phase, that is to say 30 teeth or 40 depending on whether it is of the type with five or seven phases.

In another embodiment with pole pieces with four teeth the stator body comprises in one embodiment eight teeth per phase, that is to say 40 teeth or 56 teeth depending on whether it is of the type with five or seven phases.

Naturally the alternator is in a variant brushless as described for example in the document FR 2 744 575, to which reference should be made. In this case the claw rotor comprises a stepped main pole piece carrying at its external periphery, via a non-magnetic ring, the teeth of the other pole piece with no flange, the excitation winding being carried by a core securely fixed to the casing of the alternator.

What is claimed is:

1. Polyphase stator for a rotary electrical machine with a claw rotor, comprising:
a stator body having internally a plurality of notches delimited by teeth,
each phase comprising at least one winding,
wherein combination, firstly, each phase winding comprising coils with several turns, each coil surrounds a single tooth, and secondly the stator comprises five or seven phases.

2. Polyphase stator according to claim 1, wherein the stator comprises seven phases and twenty-eight notches.

3. Polyphase stator according to claim 1, wherein the stator body has an internal diameter of between 95 millimetres and 115 millimetres.

4. Polyphase stator according to claim 1, wherein the coils are mounted around a notch insulator in order to form an assembly then slipped onto the teeth.

5. Polyphase stator according to claim 1, characterised in that the notch insulator has a bottom edge for holding the associated coil.

6. Polyphase stator according to claim 1, wherein the teeth have parallel edges and in that the turns of the coils have a constant width.

7. Polyphase stator according to claim 1, wherein the notches have parallel edges and in that the turns on the coils have a non-constant width.

8. Polyphase stator according to claim 1, wherein the coils are connected together or in a cluster in order to form a phase.

9. Polyphase stator according to claim 1, wherein the turns on a coil have variable heights.

10. Polyphase stator according to claim 1, wherein the coils are produced from a flat wire or a wire with rectangular cross section.

11. Polyphase stator according to claim 1, wherein the notches are open towards the inside.

12. Polyphase alternator or alternator starter with claw rotor, which comprises a polyphase stator comprising:
a stator body having internally a plurality of notches delimited by teeth,
each phase comprising at least one winding,
and in that, in combination, firstly, each phase winding comprising coils with several turns, each coil surrounds a single tooth, and secondly the stator comprises five or seven phases.

13. Alternator or alternator starter according to claim 12, wherein the stator is electrically connected to a rectifying device and in that the rectifying device comprises transistors of the MOSFET type.

14. Alternator or alternator starter according to claim 12, which comprises a double fan secured to the rotor and comprising two superimposed fans connected together.

15. Alternator or alternator starter according to claim 12, wherein the claw rotor comprises pole pieces each provided with teeth and in that the number of teeth on the body of the stator per phase is equal to half the number of teeth on each pole piece on the claw rotor.
